(19) United States
(12) Patent Application Publication
(10) Pub. No.: US 2016/0150524 A1
(43) Pub. Date: May 26, 2016

(54) ADAPTIVE UPLINK TRANSMISSION BASED ON CHANNEL PROFILING

(71) Applicant: QUALCOMM Incorporated, San Diego, CA (US)

(72) Inventors: Vasanth Kumar RAMKUMAR, San Diego, CA (US); Anthony FANOUS, San Diego, CA (US); Jong Hyeon PARK, San Jose, CA (US); Deepak KRISHNAMOORTHI, San Diego, CA (US); Srinivasan RAJAGOPALAN, San Diego, CA (US)

(21) Appl. No.: 14/941,109

(22) Filed: Nov. 13, 2015

Related U.S. Application Data
(60) Provisional application No. 62/083,121, filed on Nov. 21, 2014.

(51) Int. Cl. H04W 72/04; H04W 72/08

(52) U.S. Cl. CPC H04W 72/0413; H04W 72/08

(57) ABSTRACT

Certain aspects of the present disclosure provide methods for adapting one or more parameters for uplink transmissions based on a channel condition profile. An example method generally includes obtaining, from a base station, feedback relating to one or more uplink transmissions sent from the UE to a base station (BS); generating, based on the feedback, a channel condition profile of one or more channels associated with the one or more uplink transmissions; and taking one or more actions, based on the channel condition profile, to adjust at least one of a power, code rate, or modulation scheme for one or more subsequent uplink transmissions.

### CROSS-REFERENCE TO RELATED APPLICATIONS

This application claims benefit of U.S. Provisional Patent Application Ser. No. 62/083,121, entitled “Adaptive Uplink Transmission Based on Channel Profiling,” filed Nov. 21, 2014, and assigned to the assignee hereof, the contents of which are hereby incorporated by reference.

### BACKGROUND

1. Field of the Invention

Certain aspects of the present disclosure generally relate to wireless communications and, more particularly, to performing uplink transmissions using transmission parameters determined based on channel profiling.

2. Relevant Background

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

### SUMMARY

Certain aspects of the present disclosure provides a method for wireless communications by a user equipment (UE). The method generally includes obtaining, from a base station (BS), feedback relating to one or more uplink transmissions sent from the UE to a base station (BS), generating, based on the feedback, a channel condition profile of one or more channels associated with the one or more uplink transmissions, and taking one or more actions, based on the channel condition profile, to adjust at least one of a power, code rate, or modulation scheme for one or more subsequent uplink transmissions.

Certain aspects of the present disclosure provide an apparatus for wireless communications by a user equipment (UE). The apparatus generally includes a receiver configured to obtain, from a base station (BS), feedback relating to one or more uplink transmissions sent to the BS, a processor configured to generate, based on the feedback, a channel condition profile of one or more channels associated with the one or more uplink transmissions and determine one or more actions, based on the channel condition profile, to adjust at least one of a power, code rate, or modulation scheme for one or more subsequent uplink transmissions, and a transmitter configured to perform an uplink transmission based on the determined one or more actions.

Some aspects of the present disclosure provide an apparatus for wireless communications by a user equipment (UE). The apparatus generally includes means for obtaining, from a base station (BS), feedback relating to one or more uplink transmissions sent from the UE to a base station (BS), means for generating, based on the feedback, a channel condition profile of one or more channels associated with the one or more uplink transmissions, and means for taking one or more actions, based on the channel condition profile, to adjust at least one of a power, code rate, or modulation scheme for one or more subsequent uplink transmissions.

Certain aspects of the present disclosure provide a computer program product for wireless communications by a user equipment (UE) comprising a computer readable medium having instructions stored thereon. The instructions are generally executable for obtaining, from a base station (BS), feedback relating to one or more uplink transmissions sent from the UE to a base station (BS), generating, based on the feedback, a channel condition profile of one or more channels associated with the one or more uplink transmissions, and taking one or more actions, based on the channel condition profile, to adjust at least one of a power, code rate, or modulation scheme for one or more subsequent uplink transmissions.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control plane.

FIG. 6 is a diagram illustrating an example of an evolved Node B and user equipment in an access network, in accordance with certain aspects of the disclosure.

FIG. 7 illustrates example operations that may be performed by a user equipment in accordance with certain aspects of the present disclosure.

FIG. 8 illustrates a block diagram of an example process for adjusting parameters for an uplink transmission based on a channel condition profile, in accordance with certain aspects of the present disclosure.

FIG. 9 illustrates an example call flow diagram showing messages that may be exchanged between an eNB and a UE, in accordance with certain aspects of the present disclosure.

FIG. 10 illustrates an example call flow diagram showing messages that may be exchanged between an eNB and a UE, in accordance with certain aspects of the present disclosure.

### DETAILED DESCRIPTION

Aspects of the present disclosure provide techniques for adapting uplink transmissions based on a channel condition profile. The channel condition profile may be generated based on feedback regarding the uplink transmissions. The channel condition profile may indicate various information, such as, for a current condition of the channel, a transmission power and/or coding rate required to achieve a certain performance metric, such as a target block error rate (BLER), for example.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using hardware, software, or combinations thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, firmware, routines, subroutines, objects, executables, threads of execution, procedures, functions, etc., whether referred to as software/firmware, middleware, microcode, hardware description language, or otherwise.

Accordingly, in one or more exemplary embodiments, the functions described may be implemented in hardware, software, or combinations thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, PCM (phase change memory), flash memory, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

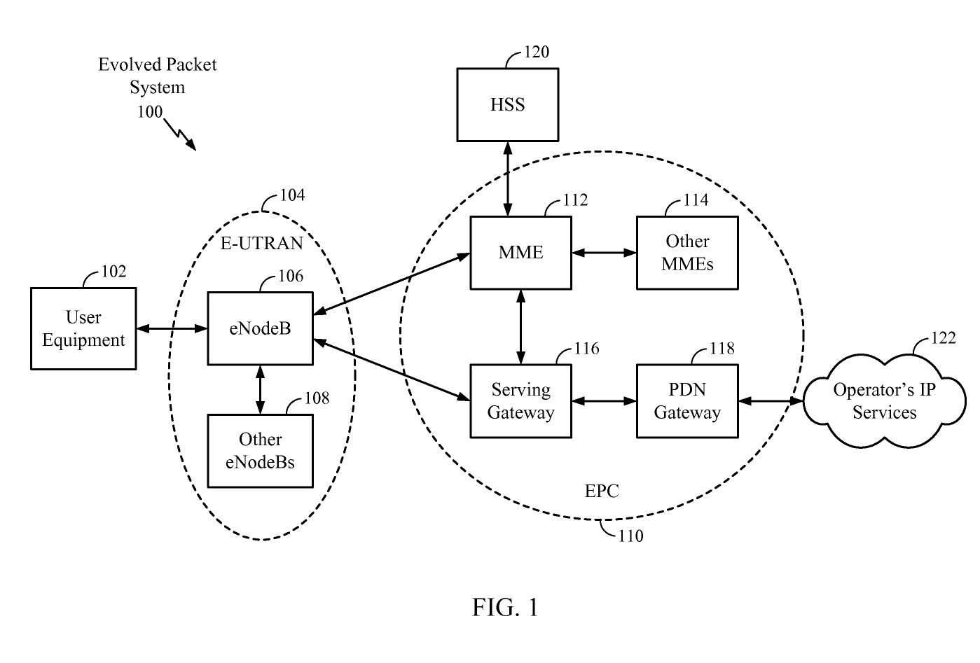

FIG. 1 is a diagram illustrating an LTE network architecture 100 in which aspects of the present disclosure may be practiced. For example, UE 102 may be configured to adapt uplink transmissions based on a channel condition profile as described herein.

The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. Exemplary other access networks may include an IP Multimedia Subsystem (IMS) PDN, Internet PDN, Administrative PDN (e.g., Provisioning PDN), carrier-specific PDN, operator-specific PDN, and/or GPS PDN. “LTE” refers generally to LTE and LTE-Advanced (LTE-A). As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control plane protocol terminations toward the UE 102. The eNB 106 may be connected to the other eNBs 108 via an X2 interface (e.g., backhaul). The eNB 106 may also be referred to as a base station, a base transceiver station, a radio base station, a radio transceiver, a transceiver function, a basic service set (BSS), an extended service set (ESS), an access point, or some other suitable terminology. The eNB 106 may provide an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a netbook, a smart book, an ultrabook, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an S1 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include, for example, the Internet, the Intranet, an IP Multimedia Subsystem (IMS), and a PS (packet-switched) Streaming Service (PSS). In this manner, the UE 102 may be coupled to the PDN through the LTE network.

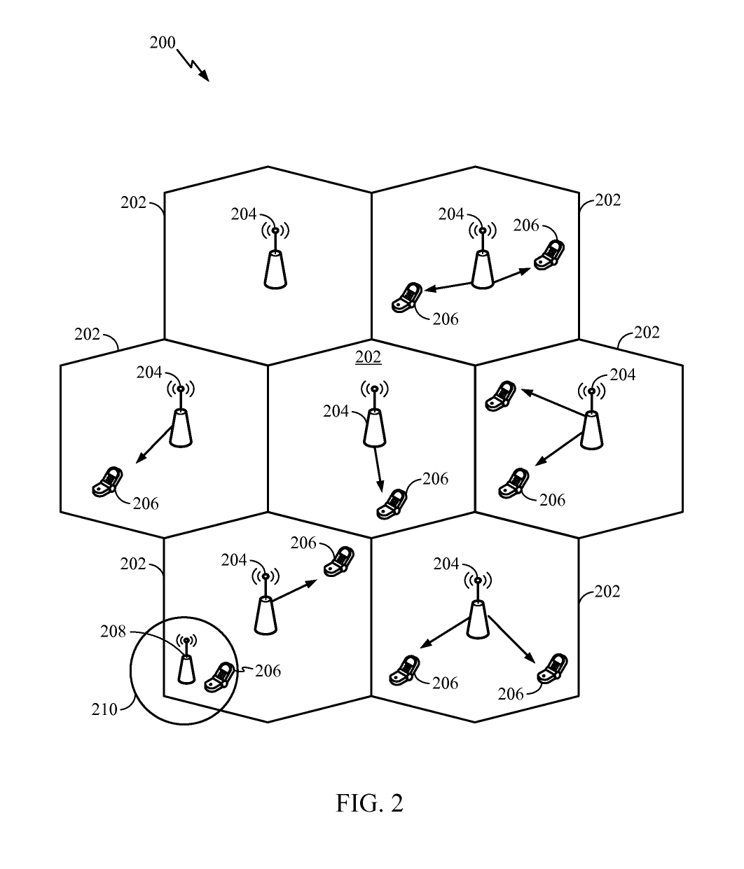

FIG. 2 is a diagram illustrating an example of an access network 200 in an LTE network architecture. Aspects of the present disclosure may be practiced in the exemplary access network 200. For example, one or more of the UEs 206 may be configured to adapt uplink transmissions based on a channel condition profile as described herein.

In this example, the access network 200 is divided into a number of cellular regions (cells) 202. One or more lower power class eNBs 208 may have cellular regions 210 that overlap with one or more of the cells 202. A lower power class eNB 208 may be referred to as a remote radio head (RRH). The lower power class eNB 208 may be a femto cell (e.g., home eNB (HeNB)), pico cell, or micro cell. The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. The network 200 may also include one or more relays (not shown). According to one application, a UE may serve as a relay.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employ CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (e.g., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

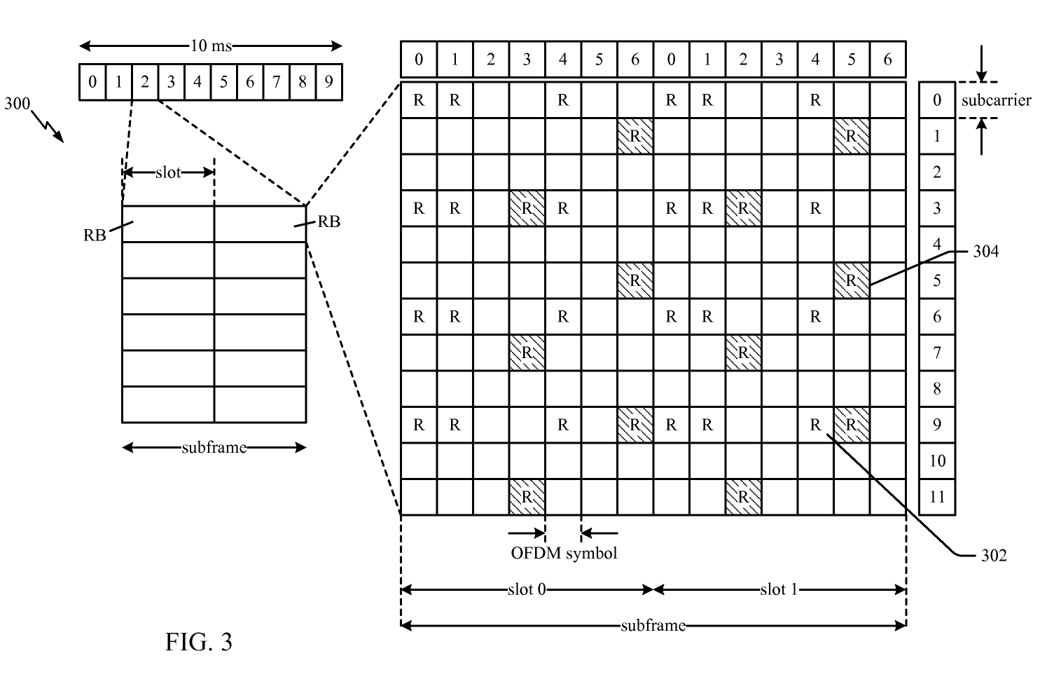

FIG. 3 is a diagram 300 illustrating an example of a DL frame structure in LTE, which may be used with the network architecture 100 shown in FIG. 1 and the access network 200 shown in FIG. 2. A frame (10 ms) may be divided into 10 equally sized sub-frames with indices of 0 through 9. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, R 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

In LTE, an eNB may send a primary synchronization signal (PSS) and a secondary synchronization signal (SSS) for each cell served by the eNB. The primary and secondary synchronization signals may be sent in symbol periods 6 and 5, respectively, in each of subframes 0 and 5 of each radio frame with the normal cyclic prefix (CP). The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. The eNB may send a Physical HARQ Indicator Channel (PHICH) and a Physical Downlink Control Channel (PDCCH) in the first M symbol periods of each subframe. The PHICH may carry information to support hybrid automatic repeat request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink.

The eNB may send the PSS, SSS, and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH, and PHICH in a broadcast manner to all UEs, may send the PDCCH in a unicast manner to specific UEs, and may also send the PDSCH in a unicast manner to specific UEs.

A number of resource elements may be available in each symbol period. Each resource element (RE) may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1, and 2. The PDCCH may occupy 9, 18, 36, or 72 REGs, which may be selected from the available REGs, in the first M symbol periods, for example. Only certain combinations of REGs may be allowed for the PDCCH. In aspects of the present methods and apparatus, a subframe may include more than one PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

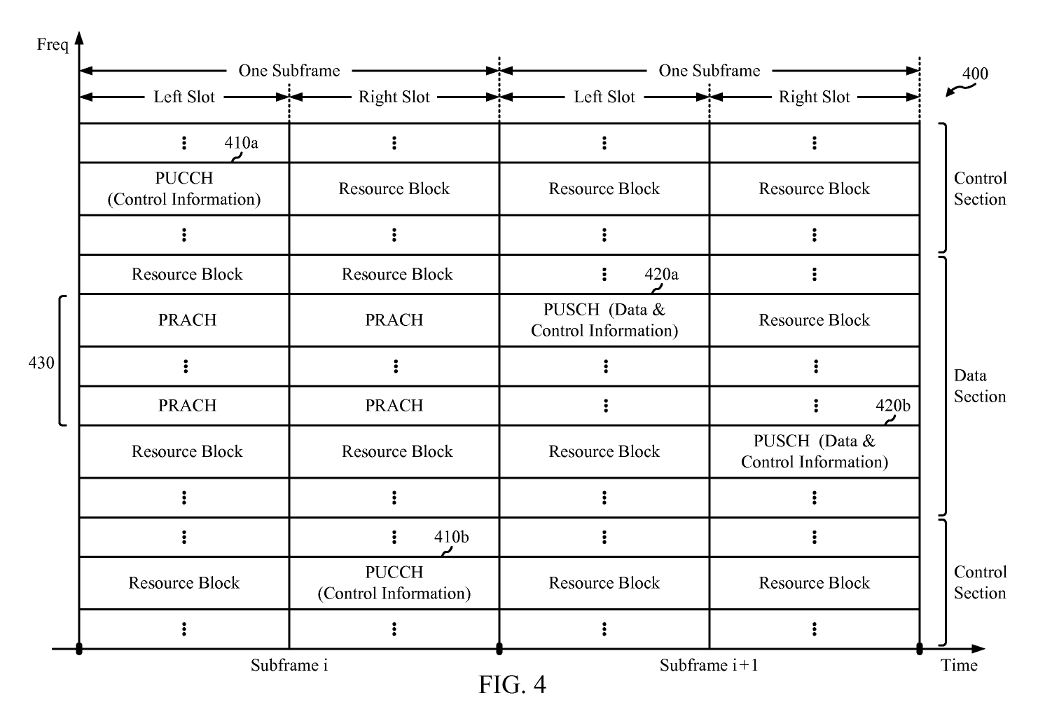

FIG. 4 is a diagram 400 illustrating an example of an UL frame structure in LTE. The exemplary UL frame structure may be used with the network architecture 100 shown in FIG. 1 and the access network 200 shown in FIG. 2. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

As described herein, a UE may generate a condition profile based on feedback related to, for example, PUCCH and/or PUSCH transmissions from an eNB and adapt uplink transmissions on PUCCH and/or PUSCH based on the channel condition profile.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

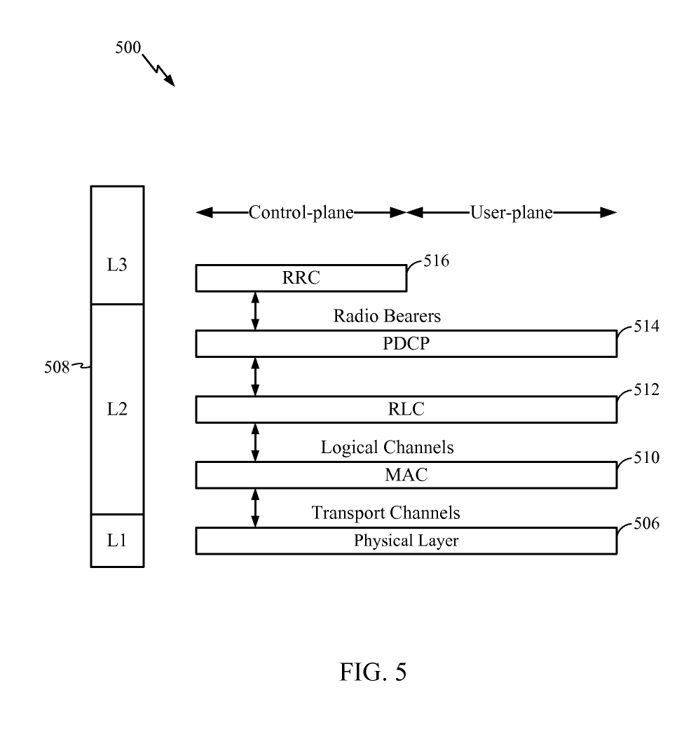

FIG. 5 is a diagram 500 illustrating an example of a radio protocol architecture for the user and control planes in LTE. The illustrated radio protocol architecture may be used with the network architecture 100 shown in FIG. 1 and the access network 200 shown in FIG. 2. Data for wireless transmission by a device (e.g., a UE, an eNB) arrives from higher layers and is processed by the various layers as they pass the data down, until it is transmitted by the lowest layer, Layer 1 (L1) 506. Processing of the data may include dividing it into packets and adding error-checking information (e.g., checksums). Data is received (e.g., over radio waves) by L1, and passed up through and processed by the higher layers. Various sublayer functions, such as the RLC sublayer, may send acknowledgments (ACKs) of received data and accept ACKs of transmitted data. When a sublayer does not receive an ACK of transmitted data, the sublayer may trigger retransmission of the data. That is, the sublayer may send the same data (e.g., data packets) to lower layers to cause the lower layers to retransmit the data.

L1 is the lowest layer of the radio protocol architecture for the UE and the ENB and implements various physical layer signal processing functions. The L1 layer will be referred to herein as the physical layer (PHY). Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ) operations. The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

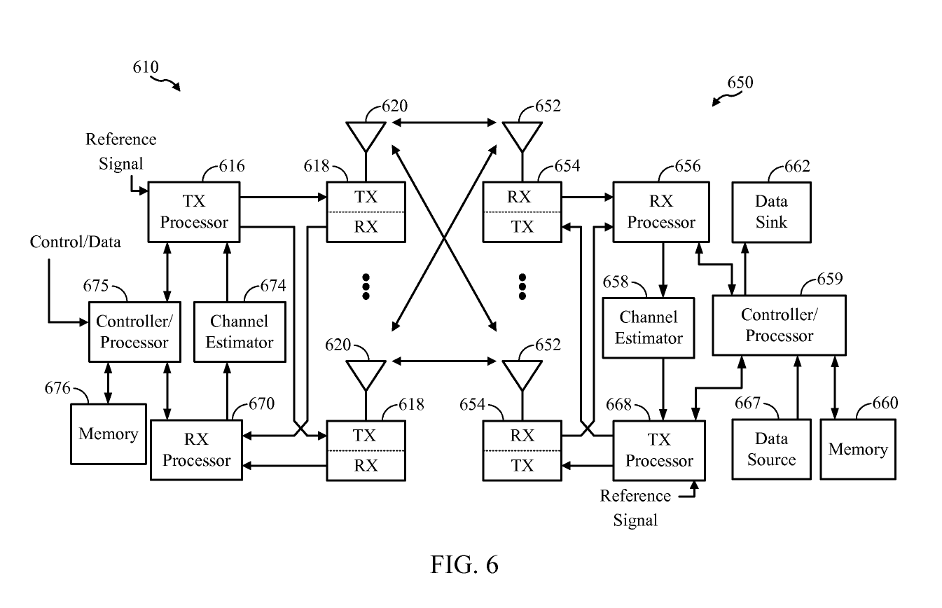

FIG. 6 is a block diagram of an eNB 610 in communication with a UE 650 in an access network. The access network may be similar to the access network 200 shown in FIG. 2, and may utilize the network architecture 100 shown in FIG. 1. Aspects of the present disclosure may be practiced in the UE 650.

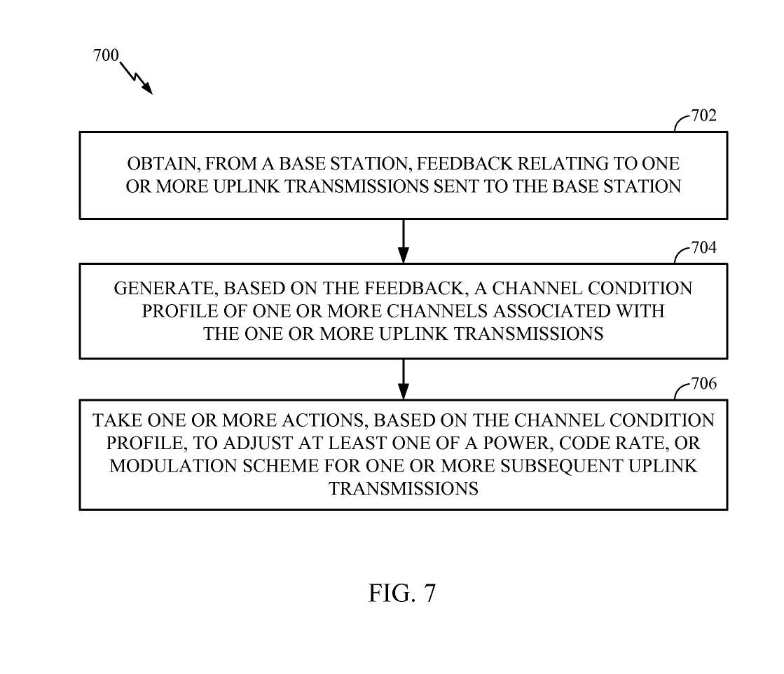

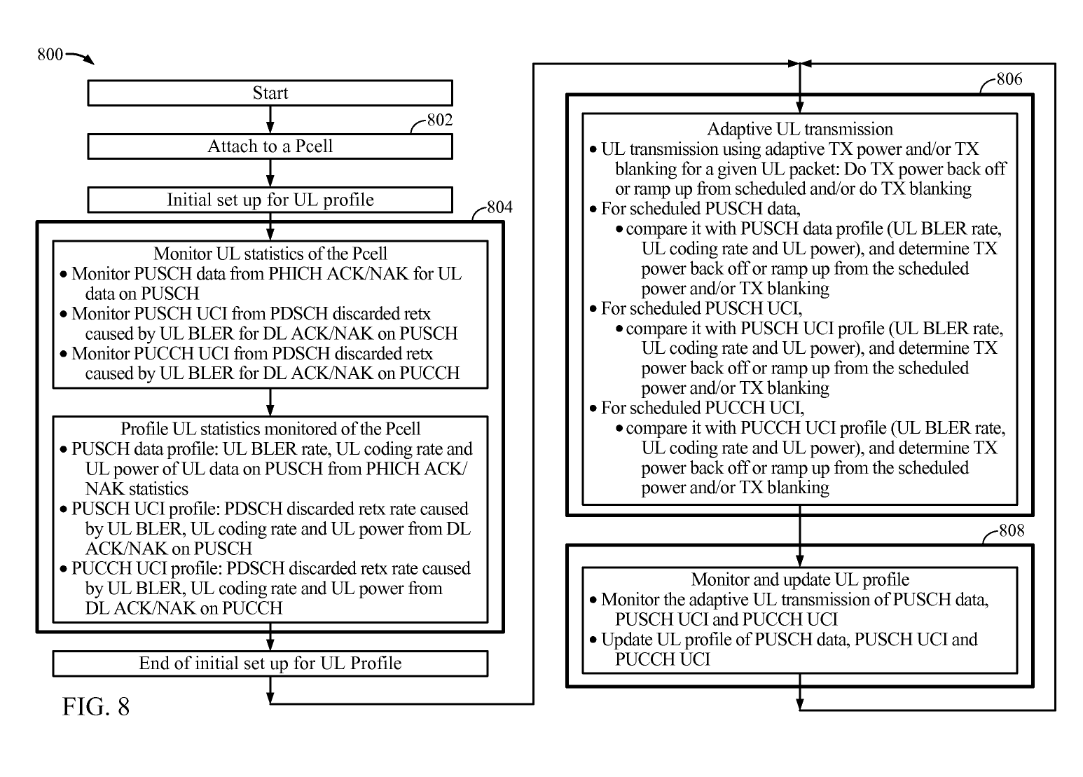

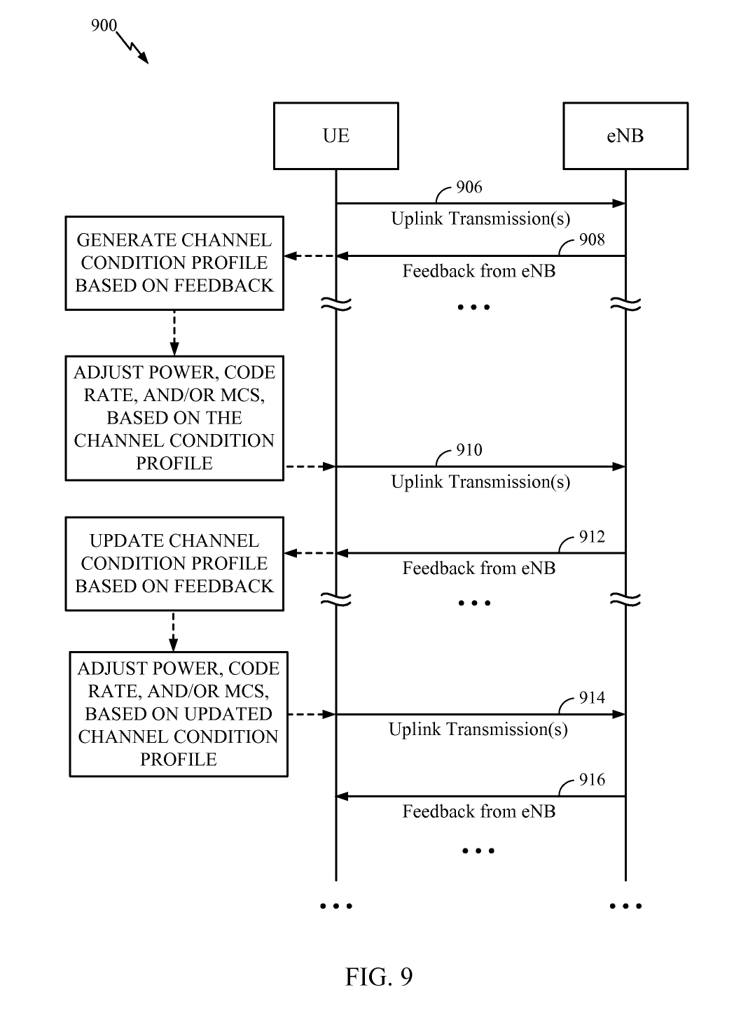

For example, the UE 650 may be configured to adapt uplink transmissions based on a channel condition profile, as described below with reference to FIG. 7, FIG. 8, and FIG. 9.

In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The TX processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receiver (RX) processor 656. The RX processor 656 implements various signal processing functions of the L1 layer. The RX processor 656 may perform or direct the UE in performing aspects of the present disclosure for adapting uplink transmissions based on a channel condition profile, such as the operations 700 described below with reference to FIG. 7. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor 659 may perform or direct the UE in performing aspects of the present disclosure for adapting uplink transmissions based on a channel condition profile, such as the operations 700 described below with reference to FIG. 7. The controller/processor 659 can be associated with a memory 660 that stores program codes and data. The memory 660 may be referred to as a computer-readable medium. The memory 660 may store instructions for performing aspects of the present disclosure for directing the UE in performing aspects of the present disclosure, such as the operations 700 described below with reference to FIG. 7. In the UL, the control/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission. The TX processor 668 may perform or direct the UE in performing aspects of the present disclosure for adapting uplink transmissions based on a channel condition profile, such as the operations 700 described below with reference to FIG. 7.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations. The controllers/processors 675, 659 may direct the operation at the eNB 610 and the UE 650, respectively. The controller/processor 659 and/or other processors and modules at the UE 650 may perform or direct operations, for example operations 700 in FIG. 7, and/or other processes for the techniques described herein, for example. In aspects, one or more of any of the components shown in FIG. 6 may be employed to perform example operations 700 and/or other processes for the techniques (e.g., adaptive uplink transmission based on channel profiling) described herein.

### Example Adaptive Uplink Transmission Based on Channel Profiling

In wireless systems, uplink transmissions may be performed using a transmission power, code rate, and/or modulation scheme assigned by a serving base station. Modulation schemes used in an uplink transmission may be determined by a serving eNB based on, for example, a signal-to-interference-plus-noise ratio (SINR). A higher-order modulation scheme may be used, for example, if a channel has a good SINR, whereas a lower-order modulation may be appropriate if a channel has a poor SINR. Such an assignment of a transmission power, code rate, and/or modulation scheme may allow for uplink transmissions to be received successfully by the base station, but may also entail performing an uplink transmission with some redundancies. These redundancies may include, for example, using a transmission power in excess of that necessary for the uplink transmission to be successful (e.g., using a greater transmission power than necessary for the uplink transmission to be successful) or performing an uplink transmission using more redundant bits (e.g., a lower coding rate) than necessary for the receiving device (e.g., a base station) to successfully receive and process the uplink transmission. As such redundancies increase the amount of power used to perform an uplink transmission, these redundancies may waste power. For battery-powered devices (e.g., a user equipment, such as a cellular phone, smartphone, wireless hotspot device, etc.), a waste of power, such as those imposed by transmission redundancies, may consequently shorten the battery life of the device.

Generally, uplink transmissions by a UE are performed according to an uplink transmission power and modulation scheme assigned by an eNodeB, for example. Modulation schemes used in an uplink transmission may be determined by a serving eNB based on, for example, a signal-to-interference-plus-noise ratio (SINR). A higher-order modulation scheme may be used, for example, if a channel has a good SINR, whereas a lower-order modulation may be appropriate if a channel has a poor SINR.

For a given scheduled uplink packet, the determined uplink transmission power and modulation scheme may introduce a variety of redundancies. For example, the transmission power and/or amount of redundant information carried in an uplink transmission may not be necessary for a successful transmission (e.g., for the uplink transmission to be successfully received by a receiving device). Performing uplink transmissions at the scheduled transmission power may use more power than is necessary for the transmission to be received. In low-code-rate situations (e.g., where a large amount of redundant information is transmitted with data), the amount of redundancy may not be necessary for the transmission to be received and decoded successfully. In such a situation, it may be possible for an uplink transmission to be successfully performed using fewer redundant bits (e.g., or symbols) than the number of redundant bits specified by the code rate.

Power amplifiers, which are used to amplify a radio frequency signal for transmission of the signal to another device, generally consume large amounts of power. Power savings may be realized, for example, if an amount of time during which the amplifier is active (e.g., amplifying a signal for transmission) is reduced or if the amount of amplification to be applied to a signal is reduced. Reducing an amount of amplification to be applied to a signal and/or reducing the size of a signal to be amplified may reduce the amount of time that an amplifier is active, which may thus reduce power usage at the amplifier and provide for power savings (and increased battery life) by a transmitting device.

According to certain aspects of the present disclosure, power savings may be realized by reducing and/or removing redundancies based on a channel condition. For example, if a UE detects that transmissions are being performed on a “good” channel (e.g., that a low number of transmissions are failing), the UE can take a variety of actions to reduce redundancies and/or save power. If transmissions are received successfully at a given transmission power level, a UE may determine that transmission power backoff, where the amount of power used to perform a transmission is decreased, may be implemented for subsequent uplink transmissions. Conversely, if transmissions are not received successfully at a given transmission power level, the UE can decrease an amount of transmission power backoff and/or increase the transmission power to be used for subsequent uplink transmissions.

In some cases, an eNB may specify the use of a low code rate (e.g., a code rate calling for a relatively large number of redundant, or parity check, bits or symbols for a given number of data bits or symbols) for uplink transmissions. Use of a low code rate may be specified, for example, by the selection of a lower value of a modulation and coding scheme (MCS). If a UE detects that uplink transmissions are being successfully received based on the assigned (low) code rate, the UE can determine that the amount of redundant bits or symbols called for by the code rate can be reduced (e.g., the excess redundant bits or symbols may be transmitted with low to no power, or otherwise blanked) with a minimal impact on reception fidelity at the BS. Conversely, if uplink transmissions are not being received successfully, the UE can increase the number of redundant bits or symbols being used to transmit a given amount of data.

As described above, determinations of changes to transmission power, code rate, and/or modulation scheme may be performed continuously (e.g., in a closed loop). Changes to transmission power, code rate, and/or modulation schemes may be used for uplink control channels, including the physical uplink control channel (PUCCH) and/or the physical uplink shared channel (PUSCH), for example. In some cases, where a channel is transmitted on multiple (a plurality of) component carriers, such changes may be performed on a per-component carrier basis.

FIG. 7 illustrates example operations 700 that may be performed by a wireless device (e.g., a user equipment) in accordance with aspects of the present disclosure. Operations 700 may begin at 702, where a UE obtains, from a base station (BS), feedback relating to one or more uplink transmissions sent from the UE to a BS. At 704, the UE generates, based on the feedback, a channel condition profile of one or more channels associated with the one or more uplink transmissions. At 706, the UE takes one or more actions, based on the channel condition profile, to adjust at least one of a power, code rate, or modulation scheme for one or more subsequent uplink transmissions.

FIG. 8 illustrates a block diagram of an example process for generating a channel condition profile for an uplink channel and/or adjusting uplink transmission parameters (e.g., power, code rate, or a modulation scheme) based on the profile. At 802, a UE may establish a connection with (or attach to) an eNB. An initial channel condition profile may be generated at 804. Generating the channel condition profile may entail monitoring PUSCH and/or PUCCH for feedback transmitted in response to uplink transmissions. Such feedback may comprise one or more metrics indicative of a quality of uplink transmissions, which may include or be derived from uplink control information (UCI), such as an acknowledgment message (ACK) or negative acknowledgment message (NACK). For example, the PUSCH may be monitored for ACKs or NACKs received for uplink data transmissions on the PUSCH. For UCI transmitted on PUSCH or PUCCH, for example, feedback may include the detection of a discarded retransmission from the eNB. In a discarded retransmission situation, a UE may successfully receive a transmission from an eNB and transmit an ACK; however, the eNB does not receive the ACK or is otherwise unable to detect the ACK and retransmits the successfully received transmission (e.g., a prior downlink transmission that was successfully received). In some cases, feedback may also include detecting the retransmission of downlink control information (DCI). For example, retransmission of an uplink resource grant in a DCI message (e.g., the DCIO message) may provide an indication of poor channel on PUSCH and/or PUCCH.

Based on the monitored statistics (e.g., a rate of ACKs, NACKs, discarded retransmissions, and/or retransmission of uplink resource grants), a channel condition profile (e.g., a PUSCH data profile, PUSCH UCI profile, and/or a PUCCH UCI profile) may be generated. Generating a profile for PUSCH data may entail a tabulation of an error rate (e.g., a block error rate (BLER), which may be a ratio of NACKs received to the number of transmissions performed overall) and correlating the error rate (e.g., BLER) to transmission parameters for the PUSCH, such as a transmit power, modulation scheme, and/or a code rate. Generating a profile for PUSCH control information and for PUCCH transmissions may entail tabulating a rate or number of discarded retransmissions on the downlink and correlating the rate or number to transmit parameters, such as power, modulation scheme, and/or a code rate.

At 806, the UE may perform uplink transmissions based on the generated channel condition profile. For data transmissions on PUSCH, the UE can compare the condition of the PUSCH with the profiles generated for PUSCH data. Based on this comparison, the UE can determine that an adjustment to a coding rate, for example, to be used for transmitting PUSCH data is warranted. For example, if the condition of PUSCH is “good,” as evidenced by a low error rate (e.g., BLER), the UE can determine that some redundant symbols called for by the specified code rate need not be transmitted, and thus, the UE may perform an uplink transmission with a number of redundant symbols transmitted at low or no power. For transmissions of control information (e.g., on PUSCH and/or PUCCH), the UE can compare a scheduled transmission power to a transmission power associated with a given observed quality metric. Based on the comparison, the UE can determine a change to one or more transmission power parameters, such as an amount of power used during an uplink transmission.

In some cases, at 806, the UE may compare a calculated BLER to a target, or expected, BLER for a given transmission power, code rate, and/or modulation scheme used for an uplink transmission. If the calculated BLER falls below the target BLER, the UE may determine that the UE is communicating with the eNB on a poor quality channel. In response, the UE may discontinue attempts to modify transmission power, code rate, and/or a modulation scheme used for an uplink transmission. In some cases, the UE may further revert to using an originally assigned transmission power, code rate, and/or modulation scheme for uplink transmissions. When the calculated BLER meets or exceeds the target BLER, the UE may restart attempts to decrease the power used for uplink transmissions to an eNB by modifying one or more of a transmission power, code rate, and/or modulation scheme.

At 808, the UE can monitor and/or update the uplink profiles. Monitoring and/or updating the profile based on subsequent adaptive transmissions and feedback may allow for a consideration of changes in channel statistics over time. For example, the channel condition profile may be based on an average error rate over a given time period (e.g., a running average). Performing updates (e.g., continuous updates) to the channel condition profiles may allow for variations in channel statistics (e.g., from UE mobility) to be accounted for in determining if adjustments to power, code rate, or modulation scheme may be warranted. In aspects, for example where carrier aggregation is configured and employed, the operations 800 for generating a channel condition profile for an uplink channel and/or adjusting uplink transmission parameters based on the profile may be employed for a channel associated with one or more of the cells related to the carrier aggregation configuration.

FIG. 9 is a message flow diagram illustrating an example exchange of messages between a UE and an eNB in accordance with certain aspects of the present disclosure. In other words, the UE may be configured to generate a channel condition profile and adapt uplink transmission parameters accordingly.

UE may perform uplink transmission(s) 906 and receive feedback 908 from the eNB relating to the uplink transmission(s) 906. The feedback may comprise, for example, an ACK, a NACK, or a retransmission of a previously acknowledged data packet. An ACK may indicate a successful transmission, while a NACK may indicate an unsuccessful transmission of uplink data, and a retransmission of a previously acknowledged data packet may indicate an unsuccessful transmission of an ACK on the uplink. The UE generates a channel condition profile based on feedback 608. Based on the channel condition profile, the UE can adjust power, code rate, and/or a modulation and coding scheme (MCS) for subsequent uplink transmissions.

The UE performs uplink transmission(s) 910 using the adjusted power code, code rate, and/or MCS based on the channel condition profile generated from feedback 908. In response to uplink transmission(s) 910, the UE receives feedback 912 from the eNB (e.g., an ACK, NACK, or retransmission of a previously acknowledged data packet). Based on feedback 912, the UE can update the channel condition profile and further adjust power, code rate, and/or MCS based on the updated channel condition profile.

Based on the adjusted power, code rate, and/or MCS from the updated channel condition profile, the UE may perform uplink transmission(s) 914 and receive feedback 916 relating to uplink transmission(s) 914 from the eNB. Performing an uplink transmission, receiving feedback, and updating a channel condition profile and choice of power- and/or time or frequency resource-saving actions based on the feedback may be performed continuously.

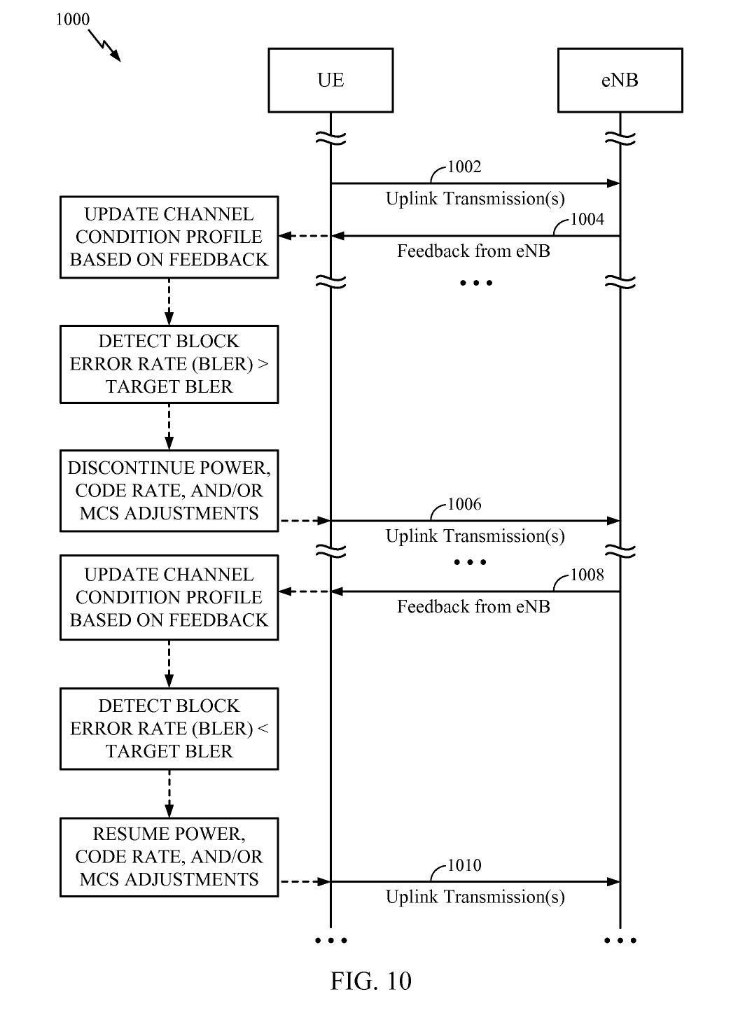

FIG. 10 is a message flow diagram illustrating an example exchange of messages between a UE and an eNB when the UE discontinues and resumes attempts to adjust uplink transmission parameters (e.g., transmission power, code rate, and/or modulation scheme) based on a channel condition profile, in accordance with certain aspects of the present disclosure. As discussed above, the UE can discontinue attempts to adjust uplink transmission parameters when a calculated channel condition profile (e.g., BLER) falls below a target value (e.g., the calculated channel condition profile value(s) exceed a low quality threshold value) and can resume such attempts when a calculated channel profile meets or exceeds a target value.

As illustrated, the UE may perform uplink transmission(s) 1002 and receive feedback 1004 from the eNB relating to the uplink transmission(s) 1002. As discussed above, the feedback may comprise, for example, an ACK, a NACK, a retransmission of an uplink resource grant (e.g., in a DCI message), or a retransmission of a previously acknowledged packet. Based on the feedback 1004, the UE updates an existing channel condition profile (e.g., a BLER). If the updated channel condition profile indicates that a calculated BLER exceeds a target BLER, the UE can discontinue performing adjustments to transmission power, code rate, and/or modulation scheme. Uplink transmission(s) 1006 may be performed using a previously assigned transmission power, code rate, and/or modulation scheme (e.g., from an initial assignment).

At a later time, the UE may receive feedback 1008 from an eNB with respect to uplink transmission(s) performed after discontinuing performing transmission power, code rate, and/or MCS adjustments. Based on feedback 1008, the UE updates the channel condition profile and detects that the calculated BLER is less than a target BLER, indicating that channel quality has improved. In response, the UE can resume performing adjustments to transmission power, code rate, and/or modulation scheme to attempt to reduce the redundancies in a transmission and save power from, for example, performing uplink transmissions to an eNB with less amplifier gain or using fewer redundant bits to transmit the same information.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

Moreover, the term “or” is intended to mean an inclusive “or” rather than an exclusive “or.” That is, unless specified otherwise or clear from the context, the phrase, for example, “X employs A or B” is intended to mean any of the natural inclusive permutations. That is, for example the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. A phrase referring to “at least one of” a list of items refers to any combination of those items, including single members. As an example, “at least one of: a, b, or c” is intended to cover: a, b, c, a-b, a-c, b-c, and a b c.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for wireless communications by a user equipment (UE), comprising:
obtaining, from a base station, feedback relating to one or more uplink transmissions sent from the UE to a base station (BS);
generating, based on the feedback, a channel condition profile of one or more channels associated with the one or more uplink transmissions; and
taking one or more actions, based on the channel condition profile, to adjust at least one of a power, code rate, or modulation scheme for one or more subsequent uplink transmissions.

2. The method of claim 1, wherein the feedback comprises feedback regarding one or more metrics indicative of a quality of uplink transmissions.

3. The method of claim 2, wherein the one or more metrics comprise one or more metrics for at least one of: one or more physical uplink shared channel (PUSCH) transmissions or one or more physical uplink control channel (PUCCH) transmissions.

4. The method of claim 3, wherein the one or more metrics comprise at least one of:
a block error rate (BLER), wherein the BLER is determined based, at least in part, on reception of negative acknowledgment (NACK) messages or retransmission of a downlink grant; or
a number of retransmissions of one or more prior downlink transmissions caused by one or more acknowledgments of the one or more prior downlink transmissions that were not successfully received by the BS on an uplink channel.

5. The method of claim 3, further comprising discontinuing taking one or more actions to adjust at least one of a power, code rate, or modulation scheme for one or more subsequent uplink transmissions if the one or more metrics exceed a target value.

6. The method of claim 3, wherein the one or more metrics comprise at least one of:
a coding rate for one or more uplink transmissions corresponding to an observed quality metric; or
an uplink transmission power corresponding to an observed quality metric.

7. The method of claim 6, wherein the observed quality metric is determined based on acknowledgment statistics for the one or more uplink transmissions.

8. The method of claim 1, wherein taking one or more actions comprises adjusting an uplink transmission power.

9. The method of claim 8, wherein adjusting the uplink transmission power comprises:
performing transmission power backoff if the channel condition profile indicates a current transmission power level is greater than a transmission power required to achieve a desired quality metric.

10. The method of claim 1, wherein taking one or more actions comprises adjusting a number of transmitted redundant symbols.

11. The method of claim 10, wherein adjusting a number of transmitted redundant symbols comprises:
reducing a number of transmitted redundant symbols if the channel condition profile indicates a current uplink transmission coding rate is less than a coding rate required to achieve a desired quality metric.

12. The method of claim 1, further comprising:
updating the channel condition profile based on feedback relating to the one or more subsequent uplink transmissions sent from the UE to a BS.

13. The method of claim 12, wherein the updating comprises:
applying a running average for one or more statistics used to generate the channel condition profile.

14. The method of claim 1, wherein the one or more channels comprise a plurality of component carriers, and wherein the generating a channel condition profile comprises generating a channel condition profile for each of the plurality of component carriers.

15. An apparatus for wireless communications by a user equipment (UE), comprising:
a transceiver configured to:
obtain, from a base station, feedback relating to one or more uplink transmissions sent from the UE to a base station (BS); and
a processor configured to:
generate, based on the feedback, a channel condition profile of one or more channels associated with the one or more uplink transmissions; and
take one or more actions, based on the channel condition profile, to adjust at least one of a power, code rate, or modulation scheme for one or more subsequent uplink transmissions.

16. The apparatus of claim 15, wherein the feedback comprises feedback regarding one or more metrics indicative of a quality of uplink transmissions.

17. The apparatus of claim 16, wherein the one or more metrics comprise one or more metrics for at least one of: one or more physical uplink shared channel (PUSCH) transmissions or one or more physical uplink control channel (PUCCH) transmissions.

18. The apparatus of claim 16, wherein the processor is further configured to:
discontinue taking one or more actions to adjust at least one of a power, code rate, or modulation scheme for one or more subsequent uplink transmissions if the one or more metrics exceed a target value.

19. The apparatus of claim 15, wherein taking one or more actions comprises at least one of:
adjusting an uplink transmission power; or
adjusting a number of transmitted redundant symbols.

20. An apparatus for wireless communications, comprising:
means for obtaining, from a base station, feedback relating to one or more uplink transmissions sent from the UE to a base station (BS);
means for generating, based on the feedback, a channel condition profile of one or more channels associated with the one or more uplink transmissions; and
means for taking one or more actions, based on the channel condition profile, to adjust at least one of a power, code rate, or modulation scheme for one or more subsequent uplink transmissions.
